(19) United States
(12) Patent Application Publication
(10) Pub. No.: US 2009/0047503 A1
(43) Pub. Date: Feb. 19, 2009

(54) Wall and Floor Tiles and Slabs Consisting of Agglomerated Stone with Photocatalytic Properties

(76) Inventors: Alessandro Godi, Verona (IT); Pierpaolo Tassone, Affi (IT)

Correspondence Address: Modiano & Associati;Via Meravigil 16, 20123, Mila, IT

(21) Appl. No.: 12/224,811

(22) PCT Filed: Mar. 8, 2007
(86) PCT No.: PCT/EP2007/002037

§ 371 Date: Sep. 5, 2008

(30) Foreign Application Priority Data
Mar. 16, 2006 (EP) 06425171.3

(51) Int. Cl. C04B 24/24; B32B 5/16

(52) U.S. Cl. 428/327; 524/2

(57) ABSTRACT

Agglomerated stone products consisting of powders and granules of marble or limestone in general, granite, quartz and silica or feldspathic sands mixed wiht resins, wherein nanometric particles of titanium dioxide are incorporated therein and process for their manufacture. Tiles and slabs for flooring, wall covering or work surface are able to interact with the surrounding environment by reducing the chemical and biological pollutants in the air and the bacteria with which the surfaces come into contact, because a photocatalytic preparation of nanometer-sized titanium dioxide is added to its composition.

### TECHNICAL FIELD

This invention relates to coverings consisting of agglomerated materials to which photocatalytic preparations of titanium dioxide (TiO₂) are added. The invention also relates to the process for the preparation of said materials, where these photocatalytic preparations are reduced to the appropriate nano-metric dimensions to be performing.

The products of the invention interact with the surrounding environment, reducing the content of bacteria, fungi, molds, VOCs (Volatile Organic Components), the NOₓ type of nitrogen oxides and other atmospheric pollutants.

### BACKGROUND ART

The manufacture of agglomerated stone products, designed for use in the building industry as floor and wall coverings or employed in furnishings as kitchen and bathroom tops or the like, is known.

These composite materials can be manufactured in the form of tiles, in slabs of over 4 square metres, with thickness ranging between 1 and 3 cm, or in blocks of up to 3 cubic metres in volume which are subsequently sawn into slabs.

The starting raw materials are marble or limestone in general, granite, quartz and silica or feldspathic sands, which can be found in nature in large pieces which need to be crushed, or in granules and sands which have already been crushed by natural events; after being suitably sorted into appropriate grading envelopes, they are bound by synthetic polymers (such as unsaturated polyester resin).

Unsaturated polyester resins are thermosetting polymers; those more useful for manufacturing agglomerated stone products are of the following type:
orthophthalic;
dicyclopentadyiene;
vynilester.

Agglomerated stone products are manufactured by different forming technologies (vibration, compression, vibration plus compression), which can be conducted either at atmospheric pressure or under vacuum.

All the forming techniques employed require raw materials which are “compatible” with one another for the manufacture of agglomerates, in order to “design” products with particular technical and aesthetic characteristics.

In this respect, agglomerates can be defined as composites, because they originate from a combination of two different materials: stone material (granulate) and binder.

Leaving aside all types of classification based on appearance, agglomerate products present a first subdivision based on the quality or type of stone granulate used, i.e. whether it consists mainly of calcium carbonate (marble or limestone) or silica (granite, feldspath, quartz or silica sand).

The granulate influences the physical, chemical and mechanical characteristics of the finished product, such as the degree of water absorption, abrasion resistance and chemical resistance.

A second classification of agglomerated products can be based on the particle-size range of the granulates in the finished product, and above on their maximum size.

This is because the binder used, and in particular its quantity in the finished product, depends mainly on the maximum diameter of the granulate (in general, the larger the maximum diameter of the granulate, the smaller the binder content, and vice versa), and this influences other characteristics, such as flexural strength and the linear thermal expansion coefficient.

Despite the minimum content required by the forming technology, the presence of binder constitutes the vehicle whereby particular additives can be added, either as part of the manufacturing process or to improve the performance of the finished product.

Said additives must be chemically compatible with the polymer used as binder.

As demonstrated by the success obtained by this product on the market for many years, the improvement and optimisation of the technical characteristics of agglomerates have made these materials increasingly suitable for all applications in the construction and interior decoration industries, due to their compatibility with other construction materials and their chemical inertia towards the environment.

As a result of these characteristics they are given the trade definition of “inerts”, on a par with natural stone and ceramic tiles.

At the same time it is also known that titanium dioxide can be used as a photocatalyst to reduce or eliminate inorganic and organic pollutants, bacteria, fungi, molds.

More specifically, it is known that titanium dioxide, in the crystalline form of anatase, is a semiconductor oxide with high reactivity which can be activated by light radiation with a wavelength present in sunlight.

The use of anatase as a photocatalyst of many pollutants has been known for some time.

Anatase is a semiconductor with a band gap at 3.2 eV: after excitation with a photon having a wavelength of less than 385 nm, it generates an electron hole on the surface of TiO₂.

The result of this process is the production of OH⁻ radicals and the reduction of O₂ to super-oxide ion (O²⁻), both of which are highly reactive on contact with organic compounds.

These radicals interact with the environment, generically reducing the pollutant content and destroying bacteria, thus effectively reducing bacterial contamination.

In the early 1980s, the first studies on the effect of TiO₂ particles on the destruction of bacteria in the presence of light allowed the photocatalysis process to be introduced as a disinfection method.

Growing interest in the potential of the favourable effects of the photodisinfection supplied by TiO₂ particles is extensively documented in the literature.

Studies have been conducted on different types of micro-organisms, such as viruses, bacteria, fungi and algae, and on cancer cells.

Its anti-bacterial effect has proved particularly effective on Gram-negative bacteria such as Escherichia coli and Pseudomonas aeruginosa, which are commonly found on work surfaces (kitchen tops, bathroom tops, and the like).

The antibacterial activity induced by light on titanium dioxide allows its use in deodorants, water and air purification, and the disinfection of various types of premises.

Other materials containing photocatalytic substances like titanium dioxide, such as grout and paint, for example, have given some interesting results in terms of reduction in nitrogen oxides (NO and NO₂), volatile organic compounds and other atmospheric pollutants.

Numerous publications illustrate the photocatalytic effect of anatase, in the presence of both solar and artificial UV irradiation, in promoting oxidation of many environmental pollutants such as NOₓ, phenols, benzene, acetaldehyde, toluene and formaldehyde, thus producing an environmental “decontamination” which is of definite practical interest.

Other publications relate to the addition of anatase nanoparticles to asphalt for the construction of city roads and pavements, while others again relate to the use of anatase for covering similar surfaces.

Some authors have reported the photocatalytic effect of anatase in promoting oxidation of NOₓ to nitrates.

Other authors have demonstrated that a surface cleaned with TiO₂ can promote the removal of NOₓ gases from the atmosphere in the presence of sunlight, by oxidising them to nitrates.

The ability to break down gaseous benzene by catalytic means at ambient temperature has been tested in special reactors.

Phenol, toluene and formaldehyde can also be eliminated by the combined effect of titanium dioxide and UV radiation.

The use of titanium dioxide nanoparticles having a photocatalytic action with the same purposes on materials such as marble, granite, stone in general and ceramic tiles is desirable for the reasons described above, but is hindered by the need to cover the surfaces of the stone materials with a titanium dioxide film a few microns thick to ensure an effective photocatalytic action and the consequent difficulty of guaranteeing the resistance of the film to the mechanical action of abrasion or the chemical action of deterioration, with a consequent loss of or reduction in photocatalytic properties during their life-time.

The state of the art comprises numerous patents disclosing the application of titanium dioxide with photocatalytic activity onto or into inorganic substrates such as: mortar, cement, concrete, ceramic material and so on.

On the contrary the use on titanium dioxide with photocatalytic activity in combination with organic substrates such as: plastics in general, paints in organic solvent, etc. has been limited by the fact that the ability of anatase to decompose the VOCs, for example, is an index of the potentiality of a chemical attack of the photocatalytic titanium dioxide on the organic substrate.

Concluding we can say that “technically” a photocatalyst is a substance that carries out one or more functions based on oxidation and reduction reactions under photoirradiation, including decomposition of air contaminants, anti bacterial and self-cleaning actions.

Therefore a photocatalytic material is a material in witch the photocatalyst is added by mixing among the components.

In the case object of the invention such photocatalytic material is intended for use in building and construction or as complement in furniture to obtain the above mentioned performances.

### DISCLOSURE OF THE INVENTION

The present invention provides agglomerated stone products consisting of powders and granules of marble or limestone in general, granite, quartz and silica or feldspathic sands mixed with resins, and having nanometric particles of titanium dioxide incorporated therein.

Particularly, this invention relates to agglomerated stone products which maintain unchanged, and in some cases actually improve, the chemical, physical and mechanical characteristics of the conventional materials currently known and used in construction and interior decoration, but can no longer be described as “inert” because, due to suitable modifications in their composition with the addition of nano-metric titanium dioxide, they can interact with the environment into which they are introduced by reducing the content of VOCs (Volatile Organic Components) and other pollutants such as NOₓ nitrogen oxides in the air that surrounds them, and the bacteria, fungi and molds with which the surfaces come into contact.

The term nano-metric indicates the prefix of an unit of measurement of 10⁻⁹ meters: therefore it is a dimension of atomic size. The nano-technology works on the atomic dimensions, from which the property of the matters is derived: it has been underlined that chemical and physical properties change when the microscopic dimension varies to the atomic and molecular one.

To understand such a phenomena we have to take into consideration the theory of the nano-particles, in which a very important parameter is the relationship between the surface area of the nano-particles and their volume.

In materials with microscopic dimensions, which have a small surface area/volume ratio the chemical and physical properties are essentially determined by the structure of the network. In materials with nano-metric dimensions which have a large surface area/volume ratio the surface characteristics become enhanced and influence the chemical and physical properties.

In general, this interaction consequently reduces or even eliminates bacteria, fungi, molds on surfaces, and reduces or gradually eliminates the organic and inorganic atmospheric pollutants present in the environment that surrounds the product.

These products can take the form of floors, walls or work surfaces (bathroom or kitchen surfaces).

The term “agglomerated stone” refers here to all materials included in the definition contained in European standard EN-14618.

The agglomerated stone according to the invention can be obtained by suitably modifying their formulation by the addition of titanium dioxide nano-particles, also selecting compatible vehicles for the addition of titanium dioxide nano-particles, thereby manufacturing a composite containing the titanium dioxide nano-particles in their structure.

The invention has been possible because it has surprisingly been found that the use in the agglomerated stones of titanium dioxide nano-particles was possible, thank to two factors:

1. the extremely efficient moulding technology either of blocks or of slabs which allows to use a minimum amount of binder (in this case a resin as a polyester resin) to realize the composite;

2. the use as binder of a cured polyester resin of appropriate structure (molecular weigh minimum 1500 units and polymer chain distribution poorly linear and enough branched).

It has been found that the combination of these two factors renders the agglomerated stones not affected in their structure by the chemical attack of the photocatalytic titanium dioxide when it is reduced at the appropriate nano-metric size: therefore the known phenomenon denominated “chalking”, due to the chemical attack of the photocatalytic titanium dioxide onto the polymer, has been found below the dimension of the surface roughness of the product.

With respect to alternative products, such as agglomerated stones with anti-microbial properties obtained adding to the mixture anti-microbial agents of the type of Trichloro-2 hydroxy-diphenil ether (trade names: Microban, Triclosan) belonging to the family of pesticide, the agglomerated stones object of the invention differ for the following reasons:
the agglomerated stones added with photocatalytic titanium dioxide preparations interact with the environment reducing the content of VOCs and other pollutants and of bacteria, fungi and molds and not only bacteria;
the mechanism of action of the photocatalytic titanium dioxide preparations is different from that of trichloro-2 hydroxy-diphenil ethers: the former is a catalyst which is always regenerated by the light while the latter is a disinfectant which is consumed in the reaction with the bacteria;
the photocatalytic titanium dioxide preparations, reacting as catalysts, eliminate the bacteria without migrating into the organic substrates (i.e. the aliments).

The product of the invention can for example contain powders and granules of marble or limestone in general, granite, quartz and silica or feldspathic sands in a total concentration ranging from 75% to 95% in volume referred to the total volume of the components and resin concentration ranging from 5% to25% in volume referred to the total volume of the components.

### Ways of Carrying Out the Invention

The agglomerated stone according to the invention can be obtained by adding particles of titanium dioxide, preferably already in nano-metric size or in a micro-metric size to be reduced and dispersed during the mixing phase, to the mixtures, and then forming or moulding the mixture with conventional techniques, for example by vibrocompacting the stone material in the presence of the resin and suitable crosslinking agents, adherence promoters and any pigments required.

The titanium dioxide particles can be added in the form of:
powders (as they are in nanometric or micrometric size or as a coating over a carrier powders);
suspensions or pastes in organic solvent.

The use of nanometre-sized powders directly added into the mixture is problematic due to the difficulty of handling them without dispersal into the environment and of successfully mixing particles with micrometer-sized granules with the finer powders of the mixes required for the manufacture of agglomerates.

Preferred is the addition of titanium dioxide in micro-metric size to be reduced and dispersed during the mixing phase.

In particular, the quantity of nanometre-sized titanium dioxide added into the mixture was between 0.5 and 10.0 w/w on the polymer, preferably between 0.5 and 5.0 w/w on the polymer.

It has also surprisingly been found that it is possible to obtain a perfect dispersion of titanium dioxide nano-particles even if they are carried in the polymer constituting the binder resin required for the manufacture of the agglomerates, without any contraindications or interference with the subsequent crosslinking (hardening) process, using an organic suspension compatible with the polymer, or a paste, or an inorganic filler coated with titanium dioxide nano-particles.

Common monoethylene, diethylene, monopropylene, dipropylene glycols or other alcohols, or monomers such as styrene, methyl methacrylate or others with different functional groups, especially acrylates or methacrylates with a suitable functional group, can be used as organic solvent or as matrix for the paste, while either calcium carbonate or feldsphatic or quartz sand can be used as inorganic carrier for the titanium dioxide nano-particles.

The organic suspension or the paste containing titanium dioxide must be mixed with the polymer under particular conditions of timing, temperature and mixing speed, in suitable reaction containers.

The mixing conditions fall approximately into the following ranges:
time: 5 to 180 minutes;
temperature: 15 to 60° C.;
mixing speed: 10 to 1250 rpm.

To obtain stable solutions, i.e. not presenting precipitation problems, the concentration of nanometre-sized titanium dioxide in the suspensions can range from a minimum of 2% to a maximum of 40% in weight, preferably from a minimum of 5% to a maximum of 25% in weight, and, in the pastes, from 40% to a maximum of 95% in weight, preferably from a minimum of 60% to a maximum of 85% in weight.

The concentration of nanometre-sized titanium dioxide in the coating of the filler can range from a minimum 1% to a maximum of 25% in weight, preferably from a minimum of 5% to a maximum of 25% in weight.

A possibility to introduce the titanium dioxide nano-particles consist in spraying them over a carrier powder (i.e. Calcium Carbonate, quartz, feldspath, silica) present in the formulation in micrometric or millimetric size.

In this case, the spray operation can be done previously and the carrier powder is introduced into the mixture as an additive or on line during the addition of the powder or fine granulate present in the formulation.

Nevertheless those skilled with the basic concepts of the agglomerated stones manufacturing process, either mould in blocks or slabs, clearly know that the variables inherent to the different phases of the process cannot be changed without preliminary studies and experimentations because the whole process is poorly flexible.

The same is for the composition of the mixtures; particularly the following parameters must be kept into consideration:
ratio between granulates and filler
ratio between filler and resin
percentage of catalyst and promoter inside the resin.

All above mentioned is connected with the reactivity of the resin which leads the hardening phase in the process. This is an exothermic reaction (i.e. with heat development) that must be conduced in predetermined times and steps.

The introduction in the mixture of a further powder (the titanium dioxide) in micro or nano-metric size affects drastically the thermal conductivity of the system conducing to a hardening process different in times and steps which must be carried out.

Thermal conductivity is the intensive property of a material that indicates its ability to conduct heat: it is defined as the quantity of heat transmitted in time through a thickness in a direction normal to a surface area due to a temperature difference under steady state conditions and when the heat transfer is dependent only on the temperature gradient.

Therefore it results that the use in a mixture which undergoes to an exothermic reaction of a powder in micro or nano-metric size, that means with extreme small dimensions (average diameter) and extreme large specific surface area, implies the resolutions of many different problems of compatibility in the process.

This fact has been outlined also if the powder in nano-metric size is added in very small percentages (below 1%): slowing-down in the hardening reaction has been seen up to 38% with the addition of 0.9% of titanium dioxide in nano-metric size, while delays of 1-2% are commonly acceptable for addition of different powders (such as silica or calcium carbonate) in high percentage (for example 23% w/w on the resin as it is usually made).

The use in the agglomerated stones of a cured polyester resin of appropriate structure (for example with molecular weight, expressed as weighted average molecular weight between 2500 and 6000 and preferred from 3500 and 5500) is necessary.

The use of titanium dioxide in the form of nano-crystalline anatase having the following characteristics is preferred:
crystal size: 5 to 100 nm (1 nm=10⁻⁹ m);
specific surface area: 300 to 10 m²/g.

According to the invention, titanium dioxide nano-particles can also be combined with metallic silver (or other metals) of nano-metric size and/or particular ions, such as Sulphur, Nitrogen, and so on, with the function of doping agents.

The concentration of metallic silver in the organic solvent ranges between 2% and 40% in weight.

This association gives rise to a synergic effect, with the result that the action of titanium dioxide is not necessarily activated in the presence of light radiation (photochemical process), but can also be activated by a chemical process.

Due to the use of said doping agents, the incorporation of metal ions consequently leads to a reduction in bacteria counts, nitrogen oxides (NO and NO₂), volatile organic compounds and other atmospheric pollutants, even in environments where no irradiation with sunlight occurs.

It is also part of the present invention the addition in the agglomerated stone mixtures of nano- and micro-particles of titanium dioxide artificially coated with non-metals, for example silica.

This combination, while remaining active against the atmospheric polluting materials, bacteria, fungi and molds, reduces the problems of compatibility of the titanium dioxide nano-particles with the organic substrate with which they enter in contact, slowing down significantly, for example, the above mentioned phenomenon of “chalking”.

As there is currently no standardised method for characterising the efficiency of photocatalytic materials, the efficiency of the photocatalytic activity of the product to which this invention relates can be evaluated by means of one of the following indicators:
measurement of the change in concentration of an atmospheric pollutant;
measurement of the reduction in the number of bacteria deposited on the surface;
measurement of the contact angle of a drop of water and/or observation of the self cleaning effect of a surface;
measurement of the colour change of an organic stain;
measurement of the formation of products of reaction from the breakdown of organic substances.

To measure the degree of pollution of enclosed premises, without any influence from the surrounding atmosphere, environmental research chambers with a volume of several cubic metres have been designed, which allowed precise control of parameters such as temperature, relative humidity, air quality and exchange: in this working area it was possible to evaluate the efficiency of the air scrubbing systems and perform evaluation studies.

Depending on the titanium dioxide content, the special products can “capture” organic and inorganic atmospheric pollutants following exposure to ultraviolet and/or solar radiation.

The broken down pollutants can then be eliminated for example by a cleavage with water; depending on the titanium dioxide concentration added, the special coverings help to reduce, for example, the levels of nitrogen oxides (NOₓ), which cause respiratory problems and contribute to the formation of smog.

NOₓ gases and organic compounds come into contact with the surface of the special products, where the presence of titanium dioxide nano-particles is activated by light radiation, breaking down the pollutants present and eliminating the products of reaction in the form of water and carbon dioxide.

The efficacy of the system is variable, depending on the spectrum and the intensity of the incident radiating power on the treated surface containing the photocatalytic substances.

The invention is described in detail in the following examples.

### EXAMPLES

### Example 1

### Bactericidal Effect of Agglomerated Stone Products Treated with Titanium Dioxide Nano-Particles

The agglomerated stone product used for the tests took the form of a tile measuring 30×30 cm with a thickness of 12 mm.

The product had the following composition:
feldspathic powders between 20 and 30% in volume
quartz chippings between 50 and 65% in volume
orthophthalic unsaturated polyester resin (weighted average molecular weight between 3500 and 5500) plus additives required for the cross-linking process (reaction catalysts, reaction promoters, adherence promoters) between 15 and 20% in volume
white pigment.

The product was formed by vibration and simultaneous compression under vacuum, and subsequently cross-linked at temperatures of between 60 and 100° C.; it was then reduced to the necessary size for the experiment by cutting to the required format.

The quantity of nanometre-sized titanium dioxide added into the mixture was between 0.5 and 5.0 w/w on the polymer.

The nano-metric titanium dioxide was introduced into the fluid by mean of a compatible fluid, such as diethylene glycol.

The reduction in the bacteria count was quantified by comparing the number of viable micro-organisms at time zero with those which were still viable after a contact time, such as 12 hours.

The actual contribution made by photocatalytic titanium dioxide to reducing the bacteria count was verified by comparing the data obtained from treated and untreated samples after exposure to UV radiation.

The entire experiment was conducted with a single species of Gram-negative bacteria (Escherichia coli).

Before inoculation onto the surface, the special covering was exposed to irradiation with U.V. type A (320-400 nm) for 30 minutes; the inoculum on the surface was 10³ and 10⁴ CFU respectively; the solution deposited, containing the bacteria, was 100 microlitres.

After 12 hours, the survival rate of the bacterial species tested was nil.

### Example 2

### Bactericidal Effect of Agglomerated Stone Tile Treated with Titanium Dioxide Nanoparticles

The agglomerated stone product used for the tests took the form of a tile measuring 30×30 cm with a thickness of 12 mm.

The product had the following composition:
calcium carbonate powders between 20 and 30% in volume
calcium carbonate chippings between 50 and 65% in volume
orthophthalic unsaturated polyester resin (weighted average molecular weight between 3500 and 5500) plus additives required for the crosslinking process (reaction catalysts, reaction promoters) between 15 and 20% in volume
white pigment.

The product was formed by vibration and simultaneous compression under vacuum, and subsequently cross-linked at temperatures of between 60 and 100° C.; it was then reduced to the necessary size for the experiment by cutting to the required format.

The quantity of nanometre-sized titanium dioxide added into the mixture was between 0.5 and 5.0 w/w on the polymer.

The nano-metric titanium dioxide was introduced into the fluid as powder of agglomerated nano-sized crystal and then dispersed in order to reach the nano-metric dimension.

The reduction in the bacteria count was quantified by comparing the number of viable micro-organisms at time zero with those which were still viable after a contact time, such as 12 hours.

The actual contribution made by photocatalytic titanium dioxide to reducing the bacteria count was verified by comparing the data obtained from treated and untreated samples after exposure to UW radiation.

The entire experiment was conducted with a single species of Gram-negative bacteria (Escherichia coli).

Before inoculation onto the surface, the special covering was exposed to irradiation with U.V. type A (320-400 nm) for 30 minutes; the inoculum on the surface was 10³ and 10⁴ CFU respectively; the solution deposited, containing the bacteria, was 100 microlitres.

After 12 hours, the survival rate of the bacterial species tested was nil.

### Example 3

### Measurement of the Change in Concentration of an Atmospheric Pollutant (NO) by the Photocatalytic Reaction of an Agglomerated Stone Treated with Titanium Dioxide Nano-Particles

The agglomerated stone product used for the tests took the form of a tile measuring 25×25 cm with a thickness of 12 mm.

The product had the following composition:
feldspathic powders between 20 and 30% in volume
quartz chippings between 50 and 65% in volume
orthophthalic unsaturated polyester resin (weighted average molecular weight between 3500 and 5500) plus additives required for the crosslinking process (reaction catalysts, reaction promoters, adherence promoters) between 15 and 20% in volume
white pigment.

The product was formed by vibration and simultaneous compression under vacuum, and subsequently cross-linked at temperatures of between 60 and 100° C.; it was then reduced to the necessary size for the experiment by cutting to the required format.

The quantity of nanometre-sized titanium dioxide added into the mixture was between 0.5 and 5.0 w/w on the polymer.

The nano-metric titanium dioxide was introduced into the fluid by mean of a compatible fluid, such as diethylene glycol.

The test of measurement of the change in concentration of an atmospheric pollutant by the photocatalytic reaction of an agglomerated stone treated with titanium dioxide nanoparticles was performed in a UAPS tester (UAPS=Urban Air Pollution Simulator). The atmospheric pollutant tested was NO and the exposure time was 180 min. During this time the sample was irradiated by UV lamps and the concentration of NO registered by sensors.

The result was that the reduction in pollutant expressed as mg was found to be 0.964 at standard condition of pressure and temperature. This means that the reduction in pollutant, at standard condition of pressure and temperature of the air, for square metre/day can be estimated in about 2 mg (with 8 hours of solar irradiation if the U.V. fraction is 5% of the total solar spectrum).

### Example 4

### Measurement of the Change in Concentration of an Atmospheric Pollutant (NO₂) by the Photocatalytic Reaction of an Agglomerated Stone Treated with Titanium Dioxide Nano-Particles

The agglomerated stone product used for the tests took the form of a tile measuring 25×25 cm with a thickness of 12 mm.

The product had the following composition:
feldspathic powders between 20 and 30% in volume
quartz chippings between 50 and 65% in volume
orthophthalic unsaturated polyester resin (weighted average molecular weight between 3500 and 5500) plus additives required for the cross-linking process (reaction catalysts, reaction promoters, adherence promoters) between 15 and 20% in volume
white pigment.

The product was formed by vibration and simultaneous compression under vacuum, and subsequently cross-linked at temperatures of between 60 and 100° C.; it was then reduced to the necessary size for the experiment by cutting to the required format.

The quantity of nanometre-sized titanium dioxide introduced into the mixture was between 0.5 and 5% in weigh on the weigh of the polymer.

The nano-metric titanium dioxide was introduced into the fluid by mean of a compatible fluid, such as diethylene glycol.

The test of measurement of the change in concentration of an atmospheric pollutant by the photocatalytic reaction of an agglomerated stone treated with titanium dioxide nanoparticles was performed in a UAPS tester (UAPS=Urban Air Pollution Simulator). The atmospheric pollutant tested was NO₂ and the exposure time was 600 min. During this time the sample was irradiated by UV lamps and the concentration of NO₂ registered by sensors.

The result was that the reduction in pollutant expressed as mg was found to be 1.603 at standard condition of pressure and temperature. This means that the reduction in pollutant, at standard condition of pressure and temperature of the air, for square metre/day can be estimated in about 1 mg (with 8 hours of solar irradiation if the U.V. fraction is 5% of the total solar spectrum).

### Example 5

The agglomerated stone product used for the tests took the form of a tile measuring 30×30 cm with a thickness of 12 mm.

The product had the following composition:
feldspathic powders between 20 and 30% in volume
quartz chippings between 50 and 65% in volume
orthophthalic unsaturated polyester (UP) resin with TiO₂ nanoparticles in the crystalline form of Anatase from 15 to 20% in volume
white pigment.

An organic/inorganic hybrid unsaturated polyester (UP) resin has been prepared by the conventional synthesis of a linear unsaturated polyester adding in the first phase at the condensation process a predetermined percentage of TiO₂ nanoparticles in the crystalline form of Anatase; The quantity of nanometre-sized titanium dioxide added into the mixture was between 0.5 and 5.0 w/w on the polymer.

The TiO₂ nanoparticles can be introduced into the reaction by a compatible carrier fluid (propylene glycol for example) or directly in form of agglomerated of nanoparticles.

The high temperature (195° C.-215° C.) of the reaction and the long time mixing during the synthesis (6-8 hours, for example) provide to disperse the nanoparticles at a dimension below the wave length of visible, so making the polyester polymer perfectly transparent.

In practice, it has been found that the subsequent dissolution of the hybrid polyester polymer into the cross-linking vinyl monomer does not present any counter indication.

Two different synthesis have been conduced in suitable pilot plan scaling the industrial plant by a factor of 700 concerning reactor, distillation column, heat exchanger, dissolution vessel so manufacturing about 20 kg of resin any time.

In the first synthesis the TiO₂ nanoparticles have been introduced into the reactor by the addition of a concentrated dispersion of propylene glycol partially substituting the propylene glycol in formula; in the second synthesis the TiO₂ have been introduced into the reactor t.q. has received from the supplier in agglomerated of crystals of dimensions ranging from 0.5 to 1 μm.

It has been noted that both the methods described above allows to use without problems powders in other ways difficult to be handled and properly dispersed in order to achieve the nanosized dimensions.

The product was formed by vibration and simultaneous compression under vacuum, and subsequently cross-linked at temperatures of between 60 and 100° C.; it was then reduced to the necessary size for the experiment by cutting to the required format.

The reduction in the bacteria count was quantified by comparing the number of viable micro-organisms at time zero with those which were still viable after a contact time, such as 12 hours.

The actual contribution made by photocatalytic titanium dioxide to reducing the bacteria count was verified by comparing the data obtained from treated and untreated samples after exposure to UV radiation.

The entire experiment was conducted with a single species of Gram-negative bacteria (Escherichia coli).

Before inoculation onto the surface, the special covering was exposed to irradiation with U.V. type A (320-400 nm) for 30 minutes; the inoculum on the surface was 10³ and 10⁴ CFU respectively; the solution deposited, containing the bacteria, was 100 microlitres.

After 12 hours, the survival rate of the bacterial species tested was <20%.

The disclosures in European Patent Application No. 06425171.3 from which this application claims priority are incorporated herein by reference.

What is claimed is:

1-26. (canceled)

27. Agglomerated stone products consisting of powders and granules of marble or limestone in general, granite, quartz and silica or feldspathic sands mixed with resins, characterised in that nanometric particles of titanium dioxide are incorporated therein.

28. Products as claimed in claim 27 wherein the titanium dioxide is in the crystalline form of anatase.

29 Products as claimed in claim 27, wherein metallic silver, preferably in the form of nanoparticles, is also incorporated therein.

30. Products as claimed in claim 27, wherein the resin is a thermosetting resin.

31. Products as claimed in claim 30, wherein the resin is an unsaturated polyester resin, preferably selected from the group consisting of an orthophthalic unsaturated resin and polyvinylester resins, or dicyclopentadyene resin.

32. Products as claimed in claim 27, wherein the titanium dioxide is mixed with the resins and/or with the powders and granules of marble or limestone in general, granite, quartz and silica or feldspathic.

33. Product as claimed in claim 27, wherein the nanometric particles of titanium dioxide is present in a total concentration ranging from 0.5% by wt to 10% by wt, preferably from 0.5% by wt to 5% by wt, referred to the total weight of the resin.

34. Process for the preparation of the products as claimed in claim 27 comprising the steps of addition of micrometric or nanometric particles of titanium dioxide to a mix consisting of powders and granules of marble or limestone in general, granite, quartz and silica or feldspathic sands mixed or to a resin, mixing the mix and the resin and forming, preferably by vibro-compactation, followed by crosslinking.

35. Process according to claim 34 wherein the particles of titanium dioxide are added as a powder.

36. Process according to claim 34 wherein the particles of titanium dioxide are added as a suspension or paste containing the particles of titanium dioxide and an organic fluid.

37. Process as claimed in claim 36, wherein the organic fluid is selected from the group consisting of alcohols, glycols, styrene, methyl methacrylate and methacrylates.

38. Process as claimed in claim 36, wherein the concentration of titanium dioxide in organic fluid ranges between 2% to 40% by weight, preferably between 5% and 25% by weight.

39. Process as claimed in claim 36, wherein the concentration of titanium dioxide in the paste ranges between 40% to 95% by weight, preferably between 60 and 85% by weight.

40. Process according to claim 34 wherein the particles of titanium dioxide are added as a coating of nanometric particles of titanium dioxide on micrometric particles of an inorganic solid carrier.

41. Process according to claim 40 wherein the carrier is selected from the group consisting of calcium carbonate, calcium feldspath and quartz.

42. Process according to claim 40 wherein the concentration of titanium dioxide ranges between 1% to 25% by weight, referred to the solid carrier.

43. Process according to claim 34 further comprising the steps of addition of particles of metallic silver, preferably as nanometric particles of metallic silver, to the mix consisting of powders and granules of marble or limestone in general, granite, quartz and silica or feldspathic sands mixed or to the resin before the step of mixing the mix and the resin or wherein the titanium dioxide is added together with metallic silver.

44. Process according to claim 43 wherein the metallic silver is added in the form of a suspension in an organic fluid, preferably with a concentration from 2% to 40% by weight of metallic silver referred to the weight of the suspension.

45. Process as claimed in claim 34, wherein the metallic silver takes the form of nanoparticles.

46. Process according to claim 34, wherein the titanium dioxide is in the crystalline form of anatase.

47. Process according to claim 34 wherein the resin is a thermosetting resin.

48. Products as claimed in claim 47, wherein the resin is an unsaturated polyester resin, preferably selected from the group consisting of an orthophthalic unsaturated resin and polyvinylester resins, or dicyclopentadyene.

49. A composite material comprising a resin and titanium dioxide in the form of nanometric particles.

50. Composite material as claimed in claim 49, wherein the resin is a thermosetting resin.

51. Material as claimed in claim 50, wherein the resin is an unsaturated polyester resin, preferably selected from the group consisting of an orthophthalic unsaturated resin and polyvinylester resins, or dicyclopentadyene.

52. Material as claimed in claim 49 wherein the titanium dioxide is in a concentration ranging from 0.5% by wt to 5% by wt referred to the total weight of the resin.
